(19) United States
(12) Patent Application Publication
(10) Pub. No.: US 2009/0183855 A1
(43) Pub. Date: Jul. 23, 2009

(54) HEAT RADIATING PLATE FOR SEMICONDUCTOR PACKAGE AND PLATING METHOD THEREOF

(75) Inventor: Shuji Negoro, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD., NAGANO-SHI (JP)

(21) Appl. No.: 12/339,725

(22) Filed: Dec. 19, 2008

(30) Foreign Application Priority Data
Dec. 21, 2007 (JP) 2007-330988

(51) Int. Cl. F28F 7/00; B05D 1/32

(52) U.S. Cl. 165/80.2; 427/300

(57) ABSTRACT

A heat radiating plate for a semiconductor package has a concave portion provided on a surface of the heat radiating plate, having an inner bottom face and an inner wall portion, a stepped portion provided on the inner wall portion of the concave portion and a plating portion covering an entire surface of the inner bottom portion of the concave portion.

### BACKGROUND OF THE INVENTION

1. Field of the Invention

The present invention relates to a heat radiating plate for a semiconductor package, which has a concave portion in a center portion of the heat radiating plate. More specifically, the present invention is directed to a heat radiating plate for a semiconductor package in which an entire portion of a bottom face portion thereof has been plated.

2. Description of Related Art

In semiconductor packages on which semiconductor elements are mounted, heat radiating plates are thermally connected to rear planes of the semiconductor elements so as to radiate heat generated from the semiconductor elements. FIG. 1 shows an example of a semiconductor package having a semiconductor element 300 mounted on a board 200, and a heat radiating plate 100 thermally connected to a rear plane of the semiconductor element 300. The heat radiating plate 100 is made of material having superior thermal conductivity such as copper and aluminum. A concave portion 150 for storing thereinto the semiconductor element 300 is provided in the heat radiating plate 100. The semiconductor element 300 is joined via a thermal interface material (will be abbreviated as “TIM”) 400 on an inner bottom face 160 of the concave portion 150.

The thermal interface material 400 has been utilized as means for thermally connecting the semiconductor element 300 to the heat radiating plate 100, while the semiconductor element 300 is not directly contracted to the heat radiating plate 100. As the material of this thermal interface material 400, indium, or the like having superior thermal conductivity are utilized.

However, when the thermal interface material 400 is melted so as to join the semiconductor element 300 to the heat radiating plate 100, voids (air holes) are produced between the semiconductor element 300 and the heat radiating plate 100. As a result, there is such a problem that the thermal conductivity is deteriorated. This is because that the voids (air holes) are produced on the joining boundary between the heat radiating plate 100 in which nickel has been plated on the material such as copper, and indium corresponding to the material of the thermal interface material 400.

Thus, it is proposed to form a gold plating 500 on a portion of an inner bottom face 160 of the heat radiating plate 100, which corresponds to the thermal interface material 400, so as to suppress the generation of the voids and securely achieve close contact between the heat radiating plate 100 and the thermal interface material 400 (see Japanese Patent Unexamined Publications JP-A-2003-37228 and JP-A-11-68360).

In the case of a multi-chip semiconductor package, since a plurality of semiconductor elements are mounted on a board, heat generated from these plural semiconductor elements must be firmly transferred to the heat radiating plate 100. As a result, the entire portion of the thermal interface material 400 located on rear planes of the plural semiconductor elements is required to be joined inside the concave portion 150 of the heat radiating plate 100. Under the above-described requirements, the gold plating must be performed to an area wider than the inner bottom face 160 to which the thermal interface material 400 is joined.

However, if gold is mistakenly plated on a foot portion 170 of the heat radiating plate 100, which is joined to the board 200 by using an adhesive agent, joining force exerted between the board 200 and the foot portion 170 is weakened. Also, since the cost of gold plating is high, there is such a requirement that only a minimum small area within the concave portion 150 of the heat radiating plate 100 is plated by employing gold, while the thermal interface material 400 is joined to the minimum small area.

Under such a requirement, the gold plating is required to be performed to an area (for example, entire area) wider than the inner bottom face 160 of the heat radiating plate 100, while the above-described area corresponds to the minimum small area to which the thermal interface material 400 is joined, and furthermore, corresponds to a sufficiently necessary area.

FIG. 2A is a sectional view for showing the known heat radiating plate 100, and FIG. 2B is a diagram for indicating a known method for performing gold plating 500 on the heat radiating plate 100. As shown in the drawings, ring-shaped mask rubber 60 is brought into abutment against the inner bottom face 160 of the heat radiating plate 100 so as to form a tightly sealed space, plating solution is poured into the tightly sealed space via a mask plate 64 and then the gold plating 500 is formed.

However, since the mask rubber 60 which tightly seals the concave portion 150 of the heat radiating plate 100 has a certain thickness, in accordance with this known plating method using such a mask rubber 60, there are some portions to which the gold plating cannot be performed within the inner bottom face 160 of the heat radiating plate 100 (refer to FIG. 2C and FIG. 2D).

### SUMMARY OF THE INVENTION

The present invention has been made to solve the above-described problem, and an object of the present invention is to provide a heat radiating plate for the semiconductor package having a concave portion in a center portion of the heat radiating plate. More specifically, the present invention has such an object to provide a heat radiating plate in which an entire inner bottom face of the concave portion has been plated, and a plating method for plating the above-described heat radiating plate.

In order to solve the above-described problems, according to an aspect of the invention, there is provided a heat radiating plate for a semiconductor package, including:

a concave portion provided on a surface of the heat radiating plate, having an inner bottom face and an inner wall portion;

a stepped portion provided on the inner wall portion of the concave portion; and

a plating portion covering an entire surface of the inner bottom portion of the concave portion.

According to another aspect of the invention, there is provided a heat radiating plate for a semiconductor package, including:

a concave portion provided on a surface of the heat radiating plate, having an inner bottom face and an inner wall portion;

an inclined portion provided on the inner wall portion of the concave portion; and

a plating portion covering an entire surface of the inner bottom portion of the concave portion.

According to still another aspect of the invention, the plating portion may be made of gold.

Further, the heat radiating plate may be rectangular as viewed from top view.

According to still another aspect of the invention, the inner wall portion may include a first inner wall defined between the inner bottom portion and the stepped portion, and

the plating portion covers the first inner wall.

Alternatively, the inner wall portion may further include a second inner wall which is positioned opposite side of the first inner wall relative to the stepped portion, and

the plating portion does not cover the second inner wall.

Further, the plating portion may cover a part of the inclined portion which is near to the inner bottom portion.

According to still another aspect of the invention, there is provided a method of plating a heat radiating plate for a semiconductor package, which includes a concave portion having an inner bottom portion and an inner wall portion,

the method including:

masking the inner wall portion except for a vicinity of the inner bottom portion; and

plating an entire surface of the inner bottom portion.

According to still another aspect of the invention,

a stepped portion or an inclined portion may be provided on the inner wall portion of the concave portion, and

the stepped portion is masked.

In accordance with the present invention, there is provided the heat radiating plate for the semiconductor packages having the concave portions and plating portion covering the entire of the inner bottom portion of the concave portion.

### BRIEF DESCRIPTION OF THE DRAWINGS

FIG. 1A is a sectional view of the known semiconductor package in which the heat radiating plate is connected to the semiconductor element;

FIG. 1B is a plan view, taken along a line B-B′ of the sectional view of FIG. 1A;

FIG. 2A is a sectional view of the known heat radiating plate;

FIG. 2B is a sectional view of the known method of plating the heat radiating plate;

FIG. 2C is a sectional view of the heat radiating plate in which the known plating method is performed;

FIG. 2D is a plan view, taken along a line D-D′ of the sectional view of FIG. 2C;

FIG. 3A is a sectional view of a heat radiating plane 1A according to a first embodiment of the present invention;

FIG. 3B is a sectional view of explaining an arrangement of the heat radiating plate 1A when plating is performed;

FIG. 3C is a sectional view of explaining a method of plating gold to the heat radiating plate 1A;

FIG. 3D is a sectional view of the heat radiating plate 1A on which gold has been plated;

FIG. 3E is a plan view, taken along a line E-E′ in the sectional view of FIG. 3D;

FIG. 4A is a sectional view of a heat radiating plate 2A according to a second embodiment of the present invention;

FIG. 4B is a sectional view of explaining an arrangement of the heat radiating plate 2A when plating is performed;

FIG. 4C is a sectional view of explaining a method of plating gold to the heat radiating plate 2A;

FIG. 4D is a sectional view of the heat radiating plate 2A on which gold has been plated; and

FIG. 4E is a plan view, a line E-E′ of the sectional view in FIG. 4D.

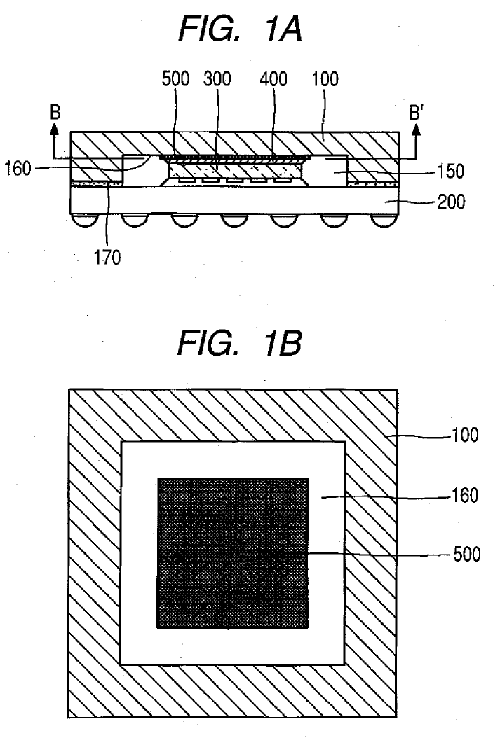

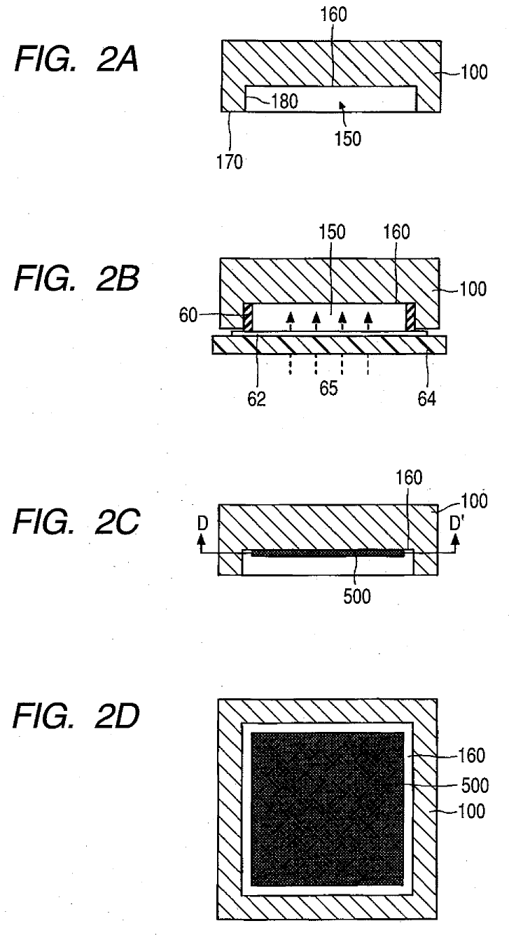

### DETAILED DESCRIPTION OF EXEMPLARY EMBODIMENTS OF THE PRESENT INVENTION

Referring now to drawings, exemplary embodiments of the present invention will be explained.

### First Embodiment

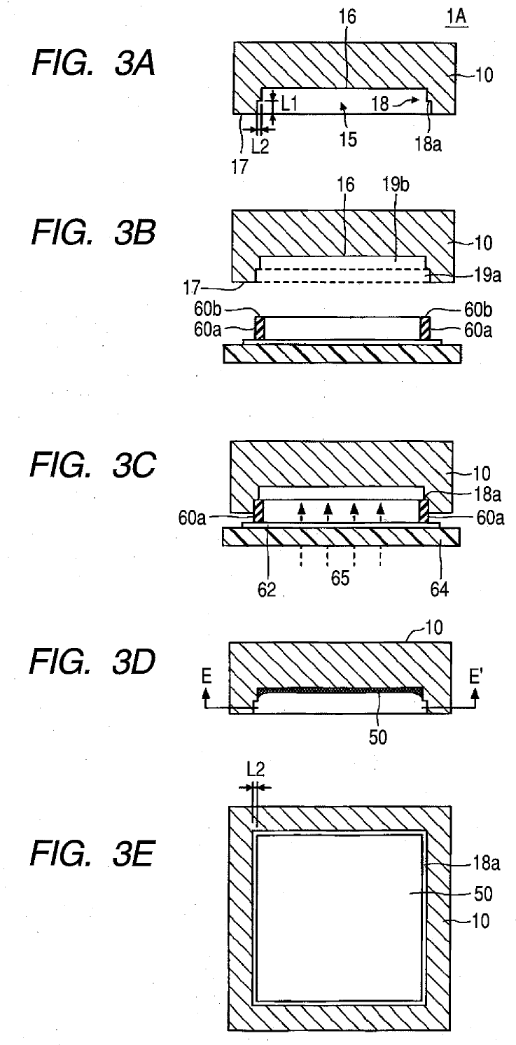

A first embodiment will be explained with reference to FIGS. 3A to 3E.

As shown in FIG. 3E, a heat radiating plate 10 according to the first embodiment is a square as viewed from a top view, and an entire shape thereof is a substantially rectangular solid. As shown in FIG. 3A, a concave portion 15 is provided on a center portion of an inner bottom face of the heat radiating plate 10, and a foot portion 17 is also provided on a circumferential portion of the bottom face. A stepped portion 18a which will constitute a mask area 19a (will be discussed later) is provided on an entire circumference of an inner wall portion 18, while the inner wall portion 18 formed between a bottom face of the foot portion 17 and an inner bottom face 16. The stepped portion 18a is provided on the inner wall portion 18 and is arranged between a first inner wall forming an outer peripheral of the inner bottom face 16 and a second inner wall forming an inner peripheral of the foot portion 17. As viewed from top view, the stepped portion 18a is positioned inside the foot portion 17, and the inner bottom face 16 is positioned inside the stepped portion 18a.

As a material of the heat radiating plate 10, such a metal as aluminum, copper, and the like having superior thermal conductivity is employed. The heat radiating plate 10 of the first embodiment is a square shape having a dimension of 30 mm×30 mm by cutting a copper plate whose thickness is about 3 mm. Dimension of the concave portion 15 is defined as approximately 20 mm (longitudinal direction), 20 mm (lateral direction), and 0.6 mm (depth direction). A width of the foot portion 17 is approximately 3 mm.

A substantially whole surface of the heat radiating plate 10 (including the inner bottom face 16 of the concave portion 15 and inner wall portion 18) is plated by nickel. It should be noted that the material, dimensions, shape, and the like of the above-descried heat radiating plate 10 are not limited only to the above-described example, but may be properly selected. For instance, a shape of the heat radiating plate 10 may be formed in a rectangle, a circle, a polygon, or the like, when viewed from top view.

Both the stepped portion 18a and a shoulder portion formed on the inner wall portion 18 of the concave portion 15 are formed in the vicinity of the inner bottom face 16. Concretely, a depth “L1” of the stepped portion 18a is selected to be on the order from 0.2 mm to 0.5 mm defined from the bottom face of the foot portion 17, and a width “L2” of the stepped portion 18a is approximately 1 mm.

As will be explained later, since a mask rubber 60a is closely contacted to the stepped portion 18a and then, the entire area of the inner bottom face 16 is plated by gold. Therefore, the stepped portion 18a is required to be set in such a manner that a distance between a tip portion 60b of the mask rubber 60a and the inner bottom face 16 of the concave portion 15 is such a value that a plating solution 65 can sufficiently spread over the entire area of the inner wall face 16 of the concave portion 15.

A portion to which the plating solution 65 is contacted constitutes a plating area 19b in the inner wall portion 18. In other words, the inner wall portion 18 is segmented into a mask area 19a and the plating area 19b (refer to FIG. 3B)

As previously described, the lengths “L1” and “L2” of the stepped portion 18a may be properly changed in accordance with the shape of the heat radiating plate 10, the thickness of the mask rubber 60a, and so on.

The above-described stepped portion 18a is utilized in order to secure that the mask rubber 60a is tightly sealed with the inner wall portion 18 when an entire area of the inner bottom face 16 is plated by gold by using the mask rubber 60a.

Next, a method for plating the heat radiating plate 1A by employing gold by performing an electrolytic plating method will be explained.

Firstly, as shown in FIG. 3B, the heat radiating plate 10, the mask rubber 60a having the rectangular sectional shape, a mask 62, and a mask plate 64 are prepared. The material of the mask rubber 60a is a silicon rubber, and the like. The heat radiating plate 10 is arranged in such a manner that the concave portion 15 opposes to a mask 62 and a mask plate 64. Next, as shown in FIG. 3C, the mask rubber 60a is closely contacted to the stepped portion 18a in order to tightly seal a space surrounded by the inner bottom face 16, the mask rubber 60a and the mask 62.

The plating solution 65 is poured from a lower portion of the mask plate 64 via holes formed in the mask plate 64 into the tightly sealed space toward the inner bottom face 16. Owing to a function of an electrolytic plating plate, gold contained in the plating solution 65 is plated on the inner bottom face 16. Although the electrolytic plating method has been employed in the first embodiment, other plating methods such as an electroless plating method may be alternatively employed in the present invention.

At this time, since the mask rubber 60a having the rectangular shape closely contacts with the stepped portion 18a along a shape of the stepped portion 18a of the inner wall portion 18, the plating solution is not blocked by the mask rubber 60a and reaches to an outer edge of the inner bottom face 16 of the heat radiating plate 10. As a consequence, as shown in FIG. 3D and FIG. 3E, since the thickness portion of the mask rubber 60a is not covered over the inner bottom face 16 of the heat radiating plate 10, gold plating (namely, gold plated layer) 50 can be carried out on the entire area of the inner bottom face 16.

The gold plated layer 50 which covers the entire inner bottom face 16 of the concave portion 15 of the heat radiating plate 10 has a thickness ranging from approximately 0.05 μm to 0.5 μm. The gold plated layer 50 secure the close contacting between the heat radiating plate 10 and the thermal interface material (MIT) 400.

It should also be noted that although a portion of the inner wall portion 18 (the first inner wall) which has not been covered by the mask rubber 60a is plated by gold, there is no problem caused by the gold plating. As described above, since an entire of the inner wall portion 18 is not plated by gold (i.e., only the first inner wall is plated), only a minimum necessary amount of the gold plating can be carried out on the heat radiating plate 10, thus the production cost can be decreased.

Also, since the mask rubber 60a is closely contacted to the stepped portion 18a, there is no possibility that the plating solution 65 is leaked out. As a result, it is possible to firmly avoid that the plating solution is leaked out to the foot portion 17 which is not required to be gold plated.

It should also be understood that if a resist, or the like is employed instead of the mask, then gold may be selectively plated. However, in this alternative case, cost is increased. Also, although a replica mask may be utilized, there are such problems that a plating solution may be leaked, and also, an aspect of mass production is deteriorated. As a consequence, as explained above, the mask rubber 60a is closely contacted to the inner wall portion 18, so that the heat radiating plate 1A which has been selectively gold plated can be mass-produced in the lower cost.

### Second Embodiment

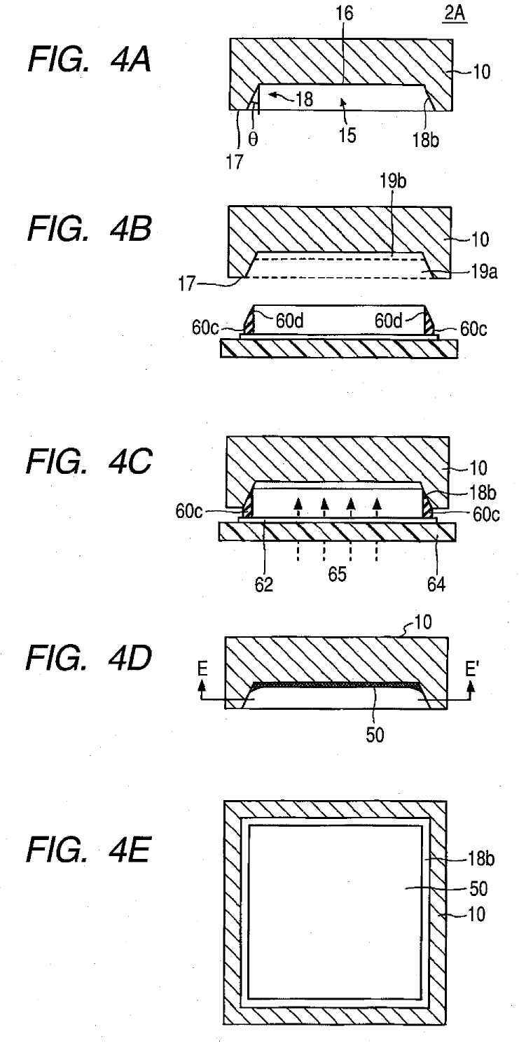

Next, a second embodiment of the present invention will be explained with reference to FIGS. 4A to 4E.

A heat radiating plate 10 according to the second embodiment is a square as viewed from a top view, and an entire shape thereof is a substantially rectangular parallelepiped. As shown in FIG. 4A, a concave portion 15 is provided in a center portion of the bottom face of the heat radiating plate 10, and a foot portion 17 is provided on a circumferential portion of the bottom face. An inclined portion 18b, where a mask area 19a (will be explained later) is formed, is provided on an entire circumference of an inner wall portion 18 which is provided between a bottom face of the foot portion 17 and an inner bottom face 16. The inclined portion 18b is inclined such that an opening area of the above-described inclined portion 18b becomes larger from the inner bottom face 16 side toward the foot portion 17 side.

As a material of the heat radiating plate 10, such a metal as aluminum, copper, and the like having superior thermal conductivity is employed. The heat radiating plate 10 of the second embodiment is a square shape having a dimension of 30 mm×30 mm by cutting a copper plate whose thickness is about 3 mm. Dimensions of the concave portion 15 are defined as approximately 20 mm (longitudinal direction), 20 mm (lateral direction), and 0.6 mm (depth direction), and a width of the foot portion 17 is approximately 3 mm.

A substantially whole surface (including the inner bottom face 16 of the concave portion 15 and the inner wall portion 18) of the heat radiating plate 10 is plated by nickel. It should be noted that the material, dimensions, shape, and the like of the above-descried heat radiating plate 10 are not limited only to the above-described example, but may be properly selected. For instance, a shape of the heat radiating plate 10 may be formed in a rectangle, a circle, a polygon, or the like, when the heat radiating plate 10 is viewed from top view.

An inclined angle “θ” of the inclined portion 18b or a tapered portion formed on the inner wall portion 18 of the concave portion 15 is approximately 5 degrees to approximately 70 degrees with respect to a vertical direction, and may be properly changed. As will be described later, this inclined portion 18b is utilized in order to secure that a mask rubber 60c is tightly sealed with the inner wall portion 18 when an entire area of the inner bottom face 16 is plated by gold by using the mask rubber 60c.

Next, a description is a method for gold plating the heat radiating plate 2A by performing an electrolytic plating method.

Firstly, as shown in FIG. 4B, the heat radiating plate 10, the mask rubber 60c, a mask 62, and a mask plate 64 are prepared. A tip portion (head portion) 60d of the mask rubber 60c is cut along an oblique direction, and the mask rubber 60c has an inclined plane whose inclined angle is nearly equal to an inclined angle of an inclined portion 18b of the heat radiating plate 10. The material of the mask rubber 60c is a silicon rubber, and the like. The heat radiating plate 10 is arranged in such a manner that the concave portion 15 is located in correspondence with both the mask 62 and the mask plate 64.

When the mask rubber 60c closely contacts with the inclined portion 18b, a distance between the tip portion 60d of the mask rubber 60c and the inner bottom face 16 of the concave portion 15 is set so that the plating solution 65 can sufficiently spread over the entire plane of the inner bottom face 16 of the concave portion 15. As previously described, a mask area 19a is formed in the vicinity of the inner bottom face 16 from a bottom face of the foot portion 17 of the inner wall portion 18 to which the mask rubber 60c is closely contacted. Also, a plating area 19b is formed in the vicinity of the inner bottom face 16 of the inner wall portion 18 to which the plating solution 65 is contacted. In other words, the inner wall portion 18 is segmented into both the mask area 19a and the plating area 19b.

As shown in FIG. 4C, the mask rubber 60c closely contacts with the inclined portion 18b, and thereafter, a tightly sealed space is formed which is surrounded by the inner bottom face 16, the mask rubber 60c, and the mask 62.

The plating solution 65 is poured from a lower portion of the mask plate 64 via holes formed in the mask plate 64 into the tightly sealed space toward the inner bottom face 16. Due to a function of an electrolytic plating plate, gold contained in the plating solution 65 is plated on the inner bottom face 16. Although the electrolytic plating method has been employed in the second embodiment, other plating methods such as an electroless plating method may be alternatively employed in the present invention.

At this time, such a mask rubber 60c whose head portion 60d has been cut along the oblique direction and the mask rubber 60c having the inclined surface of which angle is substantially same angle of the inclined portion 18b of the heat radiating plate 10 closely contacts with the inclined surface of the inclined portion 18b of the inner wall portion 18. As a result, the plating solution is not blocked from spreading over the entire surface of the inner bottom surface 16 of the heat radiating plate 10. As a consequence, as represented in FIG. 4D, since the thickness portion of the mask rubber 60c does not cover the inner bottom face 16 of the heat radiating plate 10, gold plating (namely, gold plated layer) 50 can be carried out on the entire area of the inner bottom face 16.

The gold plated layer 50 formed on the entire inner bottom face 16 of the concave portion 15 of the heat radiating plate 10 has a thickness of approximately 0.05 μm to 0.5 μm. The gold plated layer 50 securely closely contacts the heat radiating plate 10 with the thermal interface material (MIT) 400.

It should also be noted that although a portion of the inner wall portion 18 which is not been covered by the mask rubber 60c is plated by gold, there is no problem caused by the gold plating. As previously described, since only a part of the inner wall portion 18 is plated by gold, only a minimum necessary amount of the gold plating is formed on the heat radiating plate 10, and thus, the production cost can be lowered.

Further, since the mask rubber 60c closely contacts with the inclined portion 18b, there is no possibility that the plating solution 65 is leaked. As a result, it is possible to firmly avoid that the plating solution is leaked to the foot portion 17 which is not required to be plated by gold.

It should also be understood that the gold plating has been exemplified in detail with respect to the preferred embodiments of the present invention. Alternatively, the present invention may be similarly applied to other metal plating methods, instead of tin or gold. That is, while the mask rubbers are utilized, entire portions of inner bottom faces such as heat radiating plates having concave portions may be plated by employing other metals. As a consequence, the present invention is not limited only to the above-described embodiments, but may be modified, changed, and substituted in various manners within the gist of the present invention described in the scope of claims for the present invention.

What is claimed is:

1. A heat radiating plate for a semiconductor package, comprising:
a concave portion provided on a surface of the heat radiating plate, having an inner bottom face and an inner wall portion;
a stepped portion provided on the inner wall portion of the concave portion; and
a plating portion covering an entire surface of the inner bottom portion of the concave portion.

2. A heat radiating plate for a semiconductor package, comprising:
a concave portion provided on a surface of the heat radiating plate, having an inner bottom face and an inner wall portion;
an inclined portion provided on the inner wall portion of the concave portion; and
a plating portion covering an entire surface of the inner bottom portion of the concave portion.

3. The heat radiating plate as set forth in claim 1, wherein,
the plating portion is made of gold.

4. The heat radiating plate as set forth in claim 2, wherein,
the plating portion is made of gold.

5. The heat radiating plate as set forth in claim 1, wherein,
the heat radiating plate is rectangular as viewed from top view.

6. The heat radiating plate as set forth in claim 2, wherein,
the heat radiating plate is rectangular as viewed from top view.

7. The heat radiating plate as set forth in claim 1, wherein,
the inner wall portion comprises a first inner wall defined between the inner bottom portion and the stepped portion, and
the plating portion covers the first inner wall.

8. The heat radiating plate as set forth in claim 7, wherein
the inner wall portion further comprises a second inner wall which is positioned opposite side of the first inner wall relative to the stepped portion, and
the plating portion does not cover the second inner wall.

9. The heat radiating plate as set forth in claim 2, wherein,
the plating portion covers a part of the inclined portion which is near to the inner bottom portion.

10. A method of plating a heat radiating plate for a semiconductor package, which comprises a concave portion having an inner bottom portion and an inner wall portion,
the method comprising:
masking the inner wall portion except for a vicinity of the inner bottom portion; and
plating an entire surface of the inner bottom portion.

11. The method for plating the heat radiating plate as set forth in claim 10, wherein
a stepped portion is provided on the inner wall portion of the concave portion, and
the stepped portion is masked.

12. The method for plating the heat radiating plate as set forth in claim 10, wherein
an inclined portion is provided on the inner wall portion of the concave portion, and
the inclined portion is masked.

13. The method for plating the heat radiating plate as set forth in claim 10, wherein
the heat radiating plate is rectangular as viewed from top view.
